(19) United States
(12) Patent Application Publication
(10) Pub. No.: US 2005/0229952 A1
(43) Pub. Date: Oct. 20, 2005

(54) Diesel fuel injector cleaning system and method

(75) Inventor: Harold E. Erwin, Augustus, KS (US)

Correspondence Address: SHOOK, HARDY & BACON LLP, 2555 GRAND BLVD, KANSAS CITY,, MO, 64108, US

(73) Assignee: BG Products, Inc.

(21) Appl. No.: 10/828,410

(22) Filed: Apr. 20, 2004

(51) Int. Cl. B08B 9/00; B08B 3/04

(52) U.S. Cl. 134/22.1; 134/166 R; 134/169 A; 134/166 C; 134/22.11; 134/104.4

(57) ABSTRACT

Disclosed is a container including a filter which is tapped into the supply and return fuel lines of a vehicle between the tank and the engines fuel injection system. The container is filled with a cleaner which is introduced into the vehicles fuel injection system and cleans the injectors. The system is able to function without the assistance of any other supporting equipment. It simply feeds off of the existing fuel delivery system already existent in the vehicle.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The invention relates generally to the field of maintaining vehicles. More specifically, the present invention relates to cleaning the fluid systems of vehicles. Even more specifically, the present invention relates to the field of diesel engine fuel distribution system cleaning, including the diesel fuel injectors and injector pump.

2. Description of the Related Art

Fuel injection systems of vehicles are subjected to all kinds of impurities which are contained in fossil fuels purchased for consumer consumption. Even though these fossil fuels go through a refining process before being marketed, the refining process only removes some of the contaminates from the fuel. Over time, the running of fuel through the fuel system in an engine results in these contaminates being deposited on the internal surfaces of the fuel system. For example, the injectors, fuel pump internals, among others.

The fuel injectors are uniquely susceptible to contaminating deposits. This is because fuel injectors are highly engineered, high pressure sprayers. Their performance is greatly impeded when deposits form around the pintel and exit holes. This can severely restrict fuel flow through the injector. It also is likely to undesirably alter injector spray patterns. This results in power loss and poor fuel economy.

Prior art methods have been devised in an attempt to correct the problems caused by the build up of contaminants. Chemicals have been developed as fuel additives to address the problem. These chemicals are simply added to the fuel tank along with the fuel. The resulting chemical/fuel mix removes the deposits while the engine of the vehicle is active. Depending on the particular consumer's driving habits, it may be days or even weeks before the cleaner has run its course (the fuel tank is near empty).

Other fuel injector cleaning systems exist conventionally which are designed to be tapped into the vehicle's existing fuel lines. One example of such a system is disclosed in U.S. Pat. No. 4,787,348 issued to Taylor. Taylor discloses a contaminant-cleaning apparatus for diesel engines. The Taylor method involves the creation of a completely independent fuel flow system. This system requires pumping capabilities separate from those already existent in the vehicle's fuel system. It also requires a complicated electronic control and monitoring system to operate and control fuel flow during the cleaning of the engine. Also required by the Taylor system is a an electrical control valve, a power source (a 12 volt battery), and other components required to drive the separate system. The necessity of independently acting on the system fluids makes the Taylor system somewhat complex, and relatively difficult to use.

Other systems are even more unacceptably complex. Some include expensive microprocessor systems which allow the cleaning unit to switch back to the vehicle's diesel tank when the auxiliary tank in the machine runs low. Other systems use buzzers or bells to warn the operator when the tank in the cleaning system is becoming low. These devices are necessary because there is a very limited viewing area of the contents of the tank used in each system.

Therefore, a need exists in the art for a system which is simpler to use, less complex in terms of its components, yet still is capable of adequately cleaning the fuel injectors and other fuel system components without undue effort.

### SUMMARY OF THE INVENTION

The present invention solves these problems existent in the prior art devices by providing a device for cleaning a fluid system in a vehicle that uses a container including a filter. The container has a first conduit which receives fluid from the vehicle's fuel system. A typical vehicle's fuel system already has means by which fluid fuel is circulated therein. The present invention simply uses these existing means to transmit the fluid to send and receive the fluid (along with a cleaner) to a container. The container has a filter in it. A first conduit attached to the container is used to receive flowing fluid from the fluid system of the vehicle. This first conduit introduces the fluid into the container.

A second conduit is used to return fluid from the container back to the fluid system. The filter is adapted to receive the fluid introduced by the first conduit to decontaminate it. The fluid is then taken out of the container in the second conduit after it has been cleaned.

The container has space in which a cleaning solution is poured before the cleaning process begins. The fuel/cleaner combined cleaning solution will then be circulated throughout the fuel system of the engine to clean it.

The conduits are used to physically hook the container into the supply line and return line in the vehicle. These lines, when the engine is in the ordinary course of use, are what are used to deliver fuel from the fuel tank to the engine and back.

In using the device, the end of the first conduit that's not connected to the container is tapped into the return line from the engine. Likewise, the second conduit is patched into the supply line of the engine.

A pressure administrator can also be optionally used along with the container. This pressure administrator simply introduces pressure into the chamber when needed to satisfy the requirements of some diesel vehicles.

The housing of the container is substantially transparent. This enables a user to observe the fluid level within the container. Also provided to further these ends, is an indicator of scale on the housing which enables the user to match up the fluid level with a particular value.

A suspension hook is also provided that enables the container to be conveniently hung from the underside of the hood of a vehicle or in some other location.

### BRIEF DESCRIPTION OF THE SEVERAL VIEWS OF THE DRAWINGS

The present invention is described in detail below with reference to the attached drawing figures, wherein:

FIG. 1 shows the cleaning system of the present invention in use cleaning the fuel system of a vehicle engine.

FIG. 2 shows how the supply and return hoses of the vehicles fuel reservoir system are looped to return fuel pumped from the tank back to the tank.

FIG. 3 is an exploded view showing the details of all the components of the container of the present invention.

### DETAILED DESCRIPTION OF THE INVENTION

The present invention is designed to connect to a vehicle in a way that it taps into the vehicles existing fuel system. By connecting a relatively small container into the supply and return fuel lines in between the tank and the engines fuel injection system, the container is able to function without the assistance of any other supporting equipment. It simply feeds off of the existing fuel delivery system already existent in the vehicle using gravity.

The container is adapted to hold a cleaning chemical. This cleaning chemical comprises a fuel/chemical mix which will be accepted by the vehicles engine without causing failure. This fuel/chemical cleaning solution will clean the fuel system, including the injectors, of the vehicle. The vehicle's engine will continue running during the cleaning process. The chemical is specially formulated to enable this to occur without the engine dying, while at the same time enabling the fuel injectors, and other fuel system components to receive a thorough cleaning, thus removing carbon deposits and other contaminates.

The device of the present invention is very simple, and is easy to use, unlike the prior art devices. It uses a clear fiberglass housing for its container. The container comprises a transparent cylindrical body which completely exposes the contents of the tank from any angle. This makes for extremely easy viewing by the technician. It is important that the cleaning container is not allowed to run dry during the process of the present invention (as will be described hereinafter). If air gets into diesel engine's fuel systems, difficult procedures are required to purge the fuel injection system. The likelihood of encountering these types of problems is greatly reduced by the high visibility created by the transparent cylindrical body.

The present invention is primarily designed to clean the diesel fuel systems of passenger cars, pickups, and SUV's. The present invention, of course, is not intended to be limited to such applications, however diesels are especially relevant to the processes of the present invention.

The typical vehicle can be serviced very efficiently using only a quart of the proper chemical solution. Because the container of the present invention is designed to accommodate one quart, rather than a greater quantity, it is much easier to regulate the proper amount of cleaning solution to be used. This is because one filling will equate with one cleaning in terms of the volume used. Many conventional fluid exchange devices use containers designed to handle a number of services. This makes it very difficult to regulate quantities of cleaning solution used, or needed. By providing a substantially-one-quart size, the container of the present invention avoids these prior-art pitfalls. The particular size, however, of the device of the present invention is not in any way to be considered a limitation. It would be well within the knowledge of one skilled in the art to manufacture a device of much greater size, or smaller sizes to meet particular circumstances.

The cleaning device of the present invention is designed to primarily operate as a non-pressure-producing gravity-feed tool. It is normally suspended or elevated to give it gravity-induced pressure, although there is normally sufficient suction from the injector pump to pull cleaner from the tool even if it is located in a position lower than the engine's injector pump.

In certain circumstances, it may be desirable to provide a pressure-control system to elevate pressures in the container. Although a pressure control device may be desirable in some instances, it is by no means a necessity for most vehicles. In fact, the invention is normally able to act using only the already existing flow capabilities of the fuel injection system of the engine. This avoids the requirement for numerous part present in the prior art devices, such as batteries, pumps, and electric control valves. It simply draws flow from the engine itself.

When a pressure-control device is used, it is used merely to assist in the processes of purging a fuel line of air or to assist with engine startup in certain circumstances. Any pressure introduced is usually released as soon as the engine starts. Although, in certain circumstances, it may be desirable to pressurize the container throughout the service if necessary. It is, in fact, very unusual for the system of the present invention to require any pressurized air at all. This makes the invention extremely user friendly, in that it can be used virtually anywhere. It's not dependant on shop air, electrical power, or other sources only found in service shops or other places. Because of this, the invention can be taken to remote location, such as a parking lot, and used there.

The container of the present invention also contains a filter. The filter is designed to be replaced after each use, and is used to remove contaminates from the vehicle's fuel induction system during the cleaning process. The fuel that is introduced into the container from the fluid system of the engine is passed through this filter before the fuel is drawn back out of the container and reintroduced into the engine.

The filter is included in a filter housing, which includes a bypass valve. The bypass valve allows cleaner to bypass the filter if filter resistance pressure has become too great. This would happen in the event that the filter had become so dirty that it was plugged during the service. It is essentially a malfunction-prevention device.

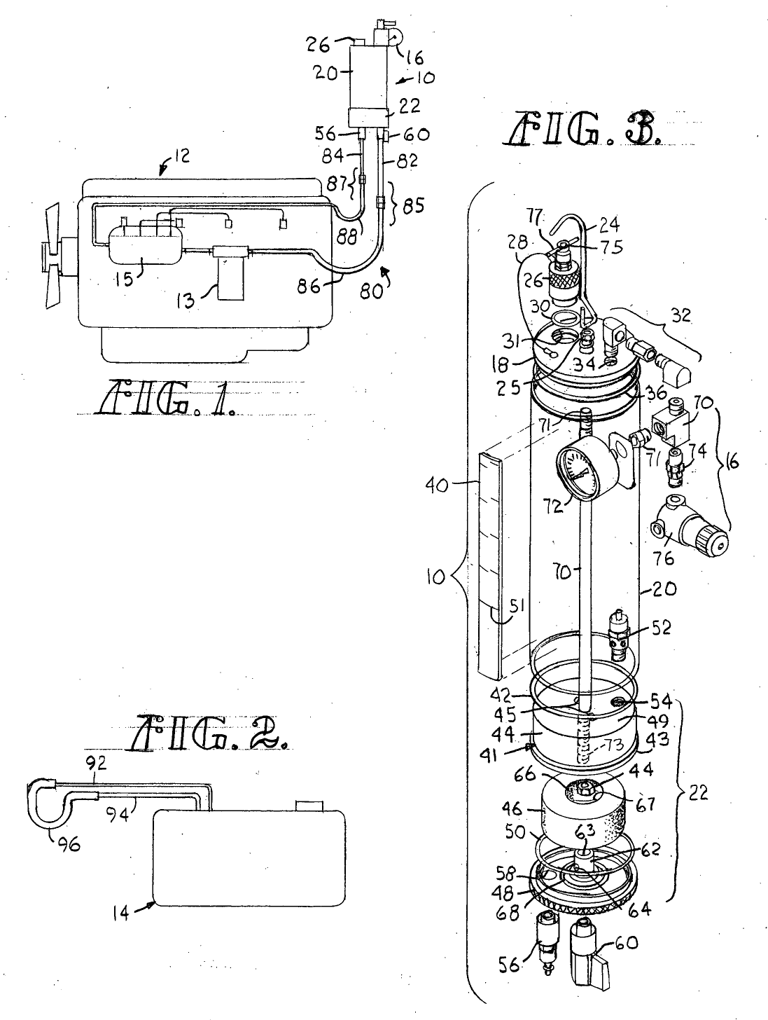

How these general ideals are accomplished is revealed by examining a specific embodiment of the present invention. This embodiment is disclosed in FIGS. 1-3. Referring first to FIG. 1, we see that a container 10 is mounted above an engine 12 of the vehicle. A pressure control system 16 is located on top of, and regulates the pressure within, container 10. Referring now to FIG. 2 we see a fuel tank of the vehicle 14 which will be later described as being involved in the processes of the present invention.

The details of container 10 of the present invention are shown in FIG. 3. Referring to FIG. 3 we see that container 10 comprises essentially three parts. First, a cap assembly 18 is used to cap off the upper end of a tubular container housing 20. Cap assembly 18 is constructed of metal, whereas transparent cylindrical body 20 is constructed of a transparent Plexiglas material. These components, of course could be constructed of other materials and still fall within the scope of the present invention. For example, cap 18 could be constructed of a durable plastic or other suitable material. Likewise, body 20 could be constructed of clear glass or some other material which would achieve the objectives here.

At the bottom of transparent cylindrical body 20 is a filter housing assembly 22. Assembly 22 seals off the opening at the lower end of transparent cylindrical body 20. Like cap assembly 18, housing assembly 22 is constructed of metal, but could also be constructed of another material which achieves the objectives of the invention.

It is preferable that body 20 be manufactured of some kind of transparent material. All of the materials used should be durable enough to be used in a shop setting or able to handle relatively rough treatment. The actual materials used, however, should not be considered to be a limitation of this invention. One skilled in the art will recognize that numerous materials could be used and still fall within the scope of the present invention.

Moving on to the details surrounding cap assembly 18, we see that a suspension hook 24 is secured to the upper surface of cap 18 by way of an attachment nut 25. It doesn't, however, really matter how hook 24 is secured to the top of the cap. It could, alternatively, be welded on or integrally formed with the cap. It exists so that container 10 may be hung from, e.g., the underside of the hood, or some other place to hang it in which it will be above the level of the engine. The container 10 could be alternatively places on a stand or platform which elevates it above the engine. The container 10 in elevated position may be seen in FIG. 1.

Another feature assembly 18 is a vented cap 26. Vented cap 26 serves two purposes. First, it is a fill cap. It is what is removed to enable the user to fill the container with the diesel/chemical cleaning solution. To do this, it is easily unscrewed from cap 18 to accommodate filling, then screwed back in.

The vented cap 26, also, as the name suggests, serves to vent the container if necessary. When a portion 75 of said vented cap 26 is unscrewed, any pressure buildup inside container 10 will be alleviated. This may have to be done if one desires to relieve the pressure in container 10. Devices such as cap 26 are know within the art and will be within the knowledge of one skilled in the art.

Vented cap 26 is maintained in the presence of cap 18 using a tether 28. Tether 28 prevents vented cap 26 from becoming lost or misplaced. Since it is not a permanently fixed component 18, there is a risk that the user may lose or misplace the vented cap 26 at key times (e.g., after filling) during the processes of the present invention. Tether 28 prevents this from happening.

When screwed into cap assembly 18, vented cap 26 forms a sealed relationship with the container using an O-ring 30. O-ring 30 is constructed of rubber, as is normally the case. When vented cap 26 is screwed into a threaded hole 31, O-ring 30 is trapped and forms a compressed seal. The threaded hole 31, as discussed above, serves as a filling hole when the vented cap 26 has been removed.

Configured onto the opposite side of cap assembly 18 are a plurality of air conducting linkages 32. Linkages 32 are merely used to transfer air from air pressure control system 16 into the container 10 when this is desired. One of the linkages 32 is threadedly received in a threaded hole 34 in cap assembly 18. An airtight seal is, of course created using gaskets, o-rings or other means which will be known to those skilled in the art.

The underside of the outside edge of cap assembly 18 forms a sealed relationship with the upper surface of the transparent cylindrical body 20. This is done using a rubber O-ring 36.

With respect to the transparent cylindrical body 20, a scale 40 is vertically fixed on the outer surface of the body 20. The transparency of body 20 enables a user to observe the fluid level within container 10. Scale 40 enables that user to affix some value to that particular level which corresponds with one of a plurality of marks 51 on scale 40.

Besides cap assembly 18 and transparent cylindrical body 20, the next major component of container 10 is the filter housing assembly 22. Filter housing 22 seals off the lower opening of cylindrical body 20. In order to do so, the cylindrical body slips around a cylindrical outside surface 44 of the filter housing. The bottom surface of the cylindrical body 20 forms a sealed relationship with filter housing 22 using a rubber O-ring 42. The O-ring 42 is trapped between the lower surface of tube 20 and a rim 43 below outside surface 44 of lid 41.

Another component of lid 41 is a top portion 47. Top portion 47 includes two filter housing apertures 45. These apertures 45 allow fluid to flow freely in and out at a radially inward position of the filter housing 22. This means fluid may be freely transmitted between the container 10 and an inside opening 66 of a filter 46.

Filter 46 is contained within lid 41. This filter 46 is generally cylindrical, however, it has a removed cylindrical portion 66, which is essentially a cylindrical void at the center axis of filter 46. Filter 46 will be trapped inside lid 41 from below by a filter cap 48 which is screwed into place.

When the filter 46 is installed in the housing lid 41, hoses 82 and 84 are attachable at a bottom surface of filter cap 48.

Cap 18, body 20, and filter housing assembly 22 are all fixed together using a bolt 70 with an upper threaded end 71 and a lower threaded end 73. Threaded 71 is partially obscured by a gage 72 of pressure control system 16 in FIG. 3. Threaded end 71 is threaded in to attachment nut 25. This secures cap 18 onto the top of cylindrical body 20. At the lower end of bolt 70, threaded end 73 receives nut 49. Nut 49 is screwed onto the threaded end 73, but nut 49 does not consume all of the threads. The remaining threads are later used to be received by a threaded opening 63 in a raised hollow cylindrical portion 62 on the upper surface of filter cap 48. Nut 49 serves merely to secure lid 41 to the bottom of body 20.

Though nuts 25 and 49, and bolt 70 obviously make cap 18 and lid 40 removable, these components will not typically be removed in the course of ordinary service. Removal is not necessary because the container may be filled through threaded hole 31, and the filter may be changed by removing filter cap 48. This is all the access necessary. Therefore, in the ordinary course of using container 10, cap 18 and housing 22 will remain secured to the housing 20 using bolt 70.

In addition to apertures 45, the top surface 47 of lid 41 has a filter bypass valve 52. The bypass valve 52 is simply screwed into a threaded receiving hole 54 on top of lid 41. Filter bypass valve 52 becomes relevant in the case of the buildup of too many contaminates within the filter. When the filter becomes too dirty during the cleaning process, it will stop transmitting fluids. When this occurs, pressure will build up. This phenomena may become a safety concern, and possibly damage the equipment. The bypass valve 52, under these circumstances, will release fluid introduced into the filter directly up into the chamber defined by the insides of transparent body 20. This release will immediately reduce any dangerous pressures to avoid damage or potential harm.

The filter cap 48 is easily removable. This will be necessary for the processes of the present invention executed in, e.g., an automotive shop. This is because it will be necessary to change filter 46 for every service preformed. Filter cap 48 is attached to the rest of container 10 as follows. At the center axis within the filter a raised hollow cylindrical portion 62 has an aperture with internal threads 63. These threads 63 will receive the threaded end at the bottom of bolt 70 to secure the entire filter housing assembly 22 to the bottom of body 20. Additionally, when filter cap 48 is screwed onto the bottom of bolt 70 it will cause the filter to be clamped within lid 41 secured from beneath by filter cap 48.

Aperture tube 62 also has a pair of fluid intake apertures 64. Only one of these apertures are shown in FIG. 3, however, a like aperture is also included at on the other, visually blocked side of the tube, directly opposite the visible aperture 64. These apertures 64 serve to draw fluid inward of filter 46.

Tube 62 is fluidly connected with a ball valve 60 from below. Ball valve assembly 60 is simply screwed into the bottom of tube 62 to enable sealed fluid communications. Valve 60 is what is used to allow the flow of cleaning solution from the container. The fluid is drawn out through the apertures 64 in tube 62 when valve 60 is opened and the vehicle is running.

Fluid is introduced into the container from the fluid system in the vehicle by way of a return hose 84. Return hose 84 is hooked up to a return hose coupler 56 which includes a check valve. Check valves allow the flow in only one direction. Here, the check valve in coupler 56 only allows flow into the container through a threaded hole 58.

Threaded hole 58 is adapted to receive reciprocating threads on the return hose coupler 56. Threaded hole 58 also serves as the induction port for the container. Fluid comes up through threaded hole 58 by way of return hose 84, then through coupler 56. This is the way the dirty fluid is introduced into the container to be filtered. Of the fluid induced through induction port 58, some will travel through filter 46 directly into apertures 64, whereas another portion of the fluid will travel through the filter, then escape up through apertures 45 into the transparent body 20 portion of the container 10 and contribute to the level of fluid existing in the container.

A circular filter ridge 68 is provided on the upper surface of the filter cap 48. This circular ridge 68 will receive the lower part of the inside cylindrical surface 67 of the filter created by void 66. When it slides into the lower part of the filter void 66 defined by the inner surface 67 of the filter 46, ridge 68 will hold the filter in a centered position on top of filter cap 48. This is so that it does not slide around, and also so it is positioned properly.

When filter 46 is properly positioned on the cap 48, there will be a gap between the inside surface of the filter 46 and tube 62 in which fluids may flow freely.

We will now discuss the pressure control system 16 of the present invention in more detail. Referring again to FIG. 3, we see that the pressure control system comprises a T-fitting 70 is screwed into the air conducting linkage system 32 in order to tap into container 10. Branching off in another direction from T-fitting 70, a link 71 extends to a gage 72. Gage 72 is a standard pressure gage. It will enable the user to observe the air pressure in the container 10.

Branching off in yet another direction from the T-fitting 70, a link 74 connects into a pressure regulator 76. Pressure regulator receives air from an air source (not pictured). The air source may be standard shop air, or come from any other suitable source. One skilled in the art will be well aware of potential sources which might be used, and the invention is not intended to be limited to any particular source of air. Almost all automotive service centers will have shop air available which will suffice for these purposes. Regulator 76 enables the user to administer or not administer air to the container. It also enables the user to set a particular pressure in the container as may be observed to the user by referencing the gage 72. As will be noted later, it may not be necessary to pressurize cylinder 10 at all, however, with some makes of vehicles and some other circumstances it may be desirable to pressurize the cylinder.

Whereas pressurization of container is accomplished using pressure controller 16, vented cap 26 is used to alleviate pressure within container 10. If pressure has been administered into container 10 using control system 16, and the user desires to release this pressure, this is done by unscrewing a screw 75 in vented cap 26 using a leverage bar 77. Leverage bar 77 is rotated by the user's fingers to unscrew screw 75. By backing out screw 75, the pressure is gradually and controllably released without the risk of cleaning solution splashing out.

We will now turn to the way in which container 10 is used along with an engine 12, as shown in FIG. 1. Referring to the figure we see that container 10 is tapped into the supply side of the fluid system of the engine (e.g. the fuel system) by way of a first conduit 85. First conduit 85 is comprised of a supply hose which runs from the container 82 and a supply hose from the vehicle's engine 86. In first conduit 85, the fluid will be moving from the engine and into the container 10.

A second conduit 87 comprises a return hose to the container 84 and a return hose from the vehicle 88. The flow of fluid in second conduit will be from the container 10 to the engine's fuel system. As will be described hereinafter, supply hose 86 and return hose 88 are already existent on the vehicle's engine. Normally these hoses connect with hoses (like conduits 92 and 94) which are connected into the engine's fuel tank (like tank 14; see FIG. 2).

FIG. 2 shows how the engine's fuel tank and associated conduits are managed in the course of the present invention. This is done by a fuel tank looping arrangement 90. A fuel tank in a vehicle 14 typically has a return line 92. Return line 92 will draw fluid from the fuel system of the vehicle and return it to the fuel tank 14. A supply line 94 is used to supply the fuel system in the vehicle. Here, however, these conduits (92 and 94) have been looped together using a looping hose 96. Looping hose 96 has been used to close off the tank's system so that there is no spillage and so that the gasoline, after it leaves tank 14 is delivered right back into the tank. It is important to note that there would normally be features present in a typical fuel delivery system fluidly associated with tank 14 which do not appear in FIG. 2. For example, the typical tank arrangement might have a booster pump which helps deliver the fuel from the tank. It may have other features which are not pictured as well. FIG. 2, however, has been simplified in order to make it more understandable and to eliminate unnecessary detail.

It is also important to note the configuration in a vehicle before the processes of the present invention are engaged in. In an ordinary vehicle, supply hose 82 in FIG. 1 will be coupled with supply hose 94 in FIG. 2. Similarly, return hose 88 in FIG. 1 will be coupled with return line 92 in FIG. 2. The combined return lines 92 and 88 are used to, as their names suggest, return fluid to the tank which is unused at that point. This returned fuel is also used to cool the injectors and other parts of the system before returning. The coupled supply hoses 94 and 86 are used, as the name suggests, to supply fuel from the tank to the fuel system in the vehicle. Here, in the processes of the present invention, however, these hoses have been uncoupled and set up in the manner shown in FIGS. 1 and 2.

Now that all the components of the system of the present invention have been described in detail, we will proceed to describe the processes of the present invention in a step by step fashion and in detail.

The first step of the process involves preparing the container to be used in the service. This is done by removing hoses 82 and 84, if they are connected to the bottom of the container. This is done so that the filter cap 48 may be removed. It will be necessary to remove filter cap 48 in order to install a new fresh filter in the device. A new fresh filter should be installed before every service, as they are not intended to be reusable. The new filter is simply placed around filter ridge 68, and the filter cap 48 is screwed on by engaging internal threads 63 on mating threads 73 at the bottom of center bolt 70. Once the filter is secured within the filter housing 22, the container should be positioned.

The container 10 should be positioned upright. It may be positioned at any elevation. However, in the preferred embodiment, it should be suspended above the vehicle's engine 12. This may be done by using hook 24 to suspend it from the underside of the vehicle's hood. It could also be placed on a support stand. Numerous options will be presented to the user for hanging the device, and it is not critical to the invention where this is done.

Now that container 10 has been properly positioned, the engine should be prepared for service. The first step in this process is to start the engine and bring it to full operating temperature. Once the engine is at full operating temperature it should be shut off.

Now that the engine has been warmed up, the container 10 is attached into the engine's fuel system in a way that it will fluidly communicate with the engine's fuel administration system. This is done by connecting hoses 82 and 84 into existing equipment on the vehicle. All diesel powered vehicles have two fuel lines that connect the fuel tank to the engine's fuel system. FIGS. 1 and 2 do not accurately depict a way in which the vehicle is typically set up during normal operation. In normal operation, supply hose 86 from the vehicle's engine is hooked up with supply line 94 from the fuel tank. Similarly, return hose 88 is normally connected up with return line 92 from the tank. Thus, in normal operation, fuel is delivered from tank 14 through supply line 94, then through supply hose 86. As will be known to one skilled in the art, once the fuel is received through supply hose 86 it will travel through the engine's fuel filter 13, and injector pump (not pictured) and into the fuel injection system 15 of the engine. Also with a typical vehicle, the total quantity of fuel delivered to the fuel injector system 15 is not used by the engine. This fuel is not used in the combustion process, and serves a collateral function. This collateral function is to help carry heat away from the injectors. To do this, it is simply circulated through the injector system for heat transfer purposes then delivered back to the tank 14 to be cooled by the much greater volume of fuel and therein maintained until redelivery into the engine system. The return of fuel is made through return hose 88 and then through return line 92 to the fuel tank 14.

In order that container 10 be connected fluidly into this existing system, the user should find a location between the vehicle's fuel tank 14 and the vehicle's fuel filter 13 where both the supply and return lines can be separated. Most modern diesel powered vehicles have easy to separate couplings which make this an easy process. As shown in FIG. 1, these couplings are shown at the ends of lines 86 and 88.

Upon disconnect, one should be very careful to avoid the unnecessary introduction of air into the engine's systems. This may occur at each of conduits 86, 88, 92, and 94. In order to avoid this, the technician want to use pinch off clips. The use of pinch off clips will be know to those skilled in the art and simply means that the conduits are pinched close to their connectors such that air is not introduced.

The couplings provided along with container 10 at the ends of conduits 82 and 84 are provided with adaptors. These coupling adapters will be able to fit into all of the kinds of connectors on lines 86 and 88 of most commercially available diesel engines. The identification of which line is the supply hose 86 and which hose is the return hose 88 is normally easy to determine. This is because the supply hose is normally red in color whereas the return hose is typically black.

Because most diesel vehicles have this color coded arrangement, supply hose 82 provided with container 10 has been made red so that the user is easily able to match it up with the supply line 86 on the vehicle. Similarly, return hose 84 on container 10 has been made black so as to match up with return hose 88 from the vehicle.

Once hoses 82 and 84 have been connected to hoses 86 and 88 from the engine, respectively, it may be necessary to loop the now disconnected conduits 92 and 94 coming from the fuel tank 14. This is because many diesels have a booster pump in the vehicle's fuel tank. The booster pump assists the transmittal of fluid from the tank to the engine. With diesels having this sort of booster pump, if conduits 92 and 94 are left disconnected during the cleaning process, fuel will be discharged onto the floor of the shop or other area in which the service is taking place. In order to prevent this, a looping hose 96 is provided in order to fluidly connect the now loose ends of conduits 92 and 94. Completion of this circuit, as shown in FIG. 2, closes off the tank's fuel system so that no fuel is spilled during the process.

Looping hose 96 has been shown in FIG. 2 in simplified version. It could be a simple conduit that forms a force fit around the connectors at the ends of hoses 92 and 94. It more likely, however, would be included with connector adaptors which would fit any of the couplings typically provided at the ends of lines 92 and 94. This is the case in the preferred embodiment. The important aspect, however, is that looping hose 96 is able to make a fluidly sealed connection between lines 92 and 94 so that fuel delivered out of tank 14 by any booster pump into supply line 94 will be returned through looping hose 96 into return line 92 and then back into the tank 14. Alternatively, of course, any such booster pump could simply be disconnected or turned off to accomplish the same goals. It has, however, been determined that this is a more difficult process than to simply hook up a looping hose like hose 96. Therefore, in the preferred embodiment, a looping hose arrangement has been used.

In order to fill the container, it will be necessary to remove the vented cap 26 form the threaded hole 31 on the lid 18. Before filling, valve 60 on the invention supply hose 82 should be opened up.

The product used to fill the container may be one of many which are commercially available. These solutions contain a quantity of fuel in combination with cleaning chemical. The fuel component is used to continue the operation of the engine during the process. The cleaner is used to clean the injectors and other components of the engine's fuel injection system. The fuel content should be sufficient to continually run the engine during the process without stalling.

Normally, it will be easy to determine a level to fill the container, the volume of the container is, in the preferred embodiment, a little more than a quart. This has proven to be a convenient size for servicing most diesels considering the typical requirements of most diesel engines. On scale 40, there will be many marks, possibly with an insignia thereon which will help identify the appropriate level to fill for individual types of engines. This enable the user to pick a specific level to fill container 10 without having to do unnecessary calculations or research, because all the fill levels for different vehicles have been predetermined, and the levels marked. The preferred product for use in filling container 10 is commercially available as BG P/N 229 which is commercially available and produced by BG Products, Inc. located in Wichita, Kans. Because it is a fuel and cleaner blend already packaged, there is no need for mixing or dilution of a cleaner.

As container 10 is being filled with fluid to the appropriate level as indicated on scale 40, (normally over a quart), the vent on the cap should be open. This prevents a vacuum from forming as the cleaner level goes down during the process. Once the container is filled, the cleaning process may begin.

Now that the equipment has been properly set up, the vehicle's engine should be started to begin the service. The user should make sure there are not leaks in the connections. Because the fuel engine's fuel supply line has been broken apart and put back together, fuel will have drained from the ends of the of the hoses near the connections, and air will have moved into these ends to replace it. If the place in which the lines have been broken and then reconnected is between the fuel tank and the engine's fuel filter, the filter will act as a diffuser to a small amount of trapped air. This will render the air harmless to the system, and the engine will be able to accommodate the small amount of air allowed by the careful disconnect and reconnection described above.

If some alternative connection is made in which the engine's fuel filter is not able to act as a diffuser, such as if the connection is not between the filter and tank, alternative care must be taken that guards against air trapping. This is done by closing valve 60 on the supply hose and filling the clear tank to its full mark. The fill plug 26 should be installed and the vent closed on it. This makes container 10 airtight. Then, by backing out regulator 76 to deliver 30 PSI (typical shop pressure) into the container 10 the canister 10 will be pressurized. The user should then determine the supply line leaving the fuel filter for the injector pumps. Using included adaptors, the user will connect the supply line from the invention to the supply line going to the injector pump. The user should then separate the return line at any accessible location and attach the return hose from the invention to the engine end of the return hose. The tank should then be looped as described above for the original arrangement. The invention should then be suspended at a position higher than the injector pump, the valve opened on the supply hose to the invention and a pressurized cleaner will help displace any air that may have been trapped in the injector pump supply hose. The engine should then be started and the vent on cap 26 be opened to release all the pressure from the cleaner tank. In some instances, it may be necessary to leave pressure on the tank in order to assure constant supply of fuel to the injector.

As the process continues with either alternative above, the level of cleaner within the container 10 will gradually lower, as will be visible through transparent body 20 and may be measured on scale 40. There will be a level line on the scale 40 which will indicate an appropriate level at which the process should be stopped. When the user observes the level of fluid coming down to this particular mark, the vehicle's engine should be shut off. Once the engine has been shut off, the ball valve 60 should be closed in order to prevent a vacuum from forming in the vehicle's supply line. It is important to note that during this process the safety margin of fluid has been calculated into the initial fill level on the container's scale to prevent air from being ingested into the engine's fuel system. After initial fill, several ounces of cleaner will always remain in the canister during the process. Once the minimal level has been reached, and the engine has been turned off, valve 60 is shut, and hoses 82 and 84 may be removed from conduits 86 and 88 coming from engine 12. Conduits 86 and 88 are then reconnected with conduits 92 and 94 of the fuel tank. To do this loop 96 must be removed and maintained by the user.

After reconnection, the engine should be started and allowed to run for a minute or two to make sure that there are no air pockets which will result in engine failure.

The fuel filter should be changed out with every service. During the process of the service, liquid fuel will have been transmitted into and out of the fuel filter by coming in port 58 through hose 84, passing through filter 46, and then being removed through the fluid intake apertures 64 in tube 62. Excess fluid may be transmitted back up into the container through filter housing apertures 45. If ever the pressure becomes too great, the incoming fluid will be able to avoid the clogged flow areas through the filter by being diverted through filter bypass valve 52 directly into container 20. This will be necessary only if the filter becomes unusually dirty during the process and the impedance of flow through the filter is too great.

The device of the present invention is able to be used service after service as long as the filter is changed.

Thus, there has been shown and described a diesel fuel injector cleaning system and method. Many changes, modifications, variations, and other uses and applications of the subject invention will, however, become apparent to those skilled in the art after considering this specification together with the accompanying figures and claims.

1. A device for cleaning a fluid system in a vehicle, said system including a flowing fluid, said device comprising:
a container including a filter;
a first conduit for receiving said flowing fluid from said fluid system and introducing said fluid into said container; and
a second conduit for returning said fluid to said fluid system;
said filter adapted to receive at least some of said fluid introduced by said first conduit to decontaminate said at least some of said fluid.

2. The device of claim 1, comprising:
a chamber in said container for receiving a cleaning solution.

3. The device of claim 1 wherein:
Said first conduit has first and second ends, said first end being connected to said container and said second end being connected to a return line which delivers said fluid from said fluid system; and
said second conduit has first and second ends, said first end being connected into said container and said second end being connected to a supply line which delivers said fluid into said fluid system.

4. The device of claim 1, comprising:
a pressure administrator for pressurizing a chamber defined within said container.

5. The device of claim 1, comprising:
a transparent portion of said housing to enable a user to observe a fluid level within said container.

6. The device of claim 5, comprising:
a scale on said housing enabling said user to match up said fluid level with a value.

7. The device of claim 1 comprising;
a suspension hook attached atop said container for hanging said container.

8. The device of claim 1 comprising:
a vented cap.

9. The device of claim 1, wherein said container includes:
a cylindrical body with openings at each end;
a cap enclosing one of said openings; and
a filter housing enclosing the other of said openings; said filter being disposed in said filter housing.

10. The device of claim 9 comprising:
an induction port which receives said fluid introduced via said first conduit and transmits said fluid into said filter.

11. The device of claim 9 comprising:
a fluid exit port positioned proximate the center of said filter, said port allowing said fluid to exit from said container to be returned to said fluid system in said vehicle through said second conduit after passing through said filter.

12. The device of claim 11 comprising:
at least one induction aperture on said filter housing, said reduction aperture located in a position which requires said fluid to flow through at least a portion of said filter before exiting said container through said exit port.

13. A method for cleaning a fluid system in a vehicle, said system having a fluid supply and a fluid return, comprising:
providing a container, said container including a filter;
tapping said container into both of said fluid supply and said fluid return;
introducing said fluid into said container via said fluid return;
running at least some of said fluid through said filter; and
transmitting said fluid back to said fluid system in said vehicle via said fluid supply.

14. The method of claim 13 comprising:
including a cleaning solution in said container to be circulated in said fluid system in said vehicle along with said fluid to stimulate the removal of contaminating deposits form said fluid system.

15. The method of claim 13 comprising:
pressurizing said container.

16. The method of claim 13 comprising:
venting the container.

17. The method of claim 13 wherein said fluid supply includes a supply line which delivers said fluid from a fluid source in said vehicle to said fluid system and said fluid return includes a return line which returns said fluid form said fluid system to said fluid source in said vehicle, comprising:
breaking said supply line into first and second supply line portions, said first supply line portion running to the fluid system in the vehicle, said second supply line portion running to the fluid source in the vehicle;
breaking said return line into first and second return line portions, said first return line portion running to the fluid system in the vehicle, said second return line portion running to the fluid source in the vehicle;
connecting said first supply line portion into said container to comprise said fluid supply; and
connecting said first return line portion into said container to comprise said fluid return.

18. The method of claim 17 comprising:
connecting said second supply line portion to said second return line portion to loop and fluid drawn out of said source back into said source.

19. The method of claim 13 comprising:
running all of said fluid through said filter.
